(19) United States
(12) Patent Application Publication
(10) Pub. No.: US 2015/0269134 A1
(43) Pub. Date: Sep. 24, 2015

(54) METHOD OF ANNOTATING A DOCUMENT DISPLAYED ON AN ELECTRONIC DEVICE

(71) Applicants: Douglas R. COCHRAN, Novato, CA (US); Kevan CHAPMAN, Novato, CA (US); Robert MAYER, Novato, CA (US); Royal FARROS, Novato, CA (US); IMSI DESIGN, LLC, Novato, CA (US)

(72) Inventors: Douglas R. Cochran, Novato, CA (US); Kevan Chapman, Novato, CA (US); Robert Mayer, Novato, CA (US); Royal Farros, Novato, CA (US)

(73) Assignee: IMSI DESIGN, LLC, Novato, CA (US)

(21) Appl. No.: 14/435,447

(22) PCT Filed: Oct. 11, 2013
(86) PCT No.: PCT/US13/64721

§ 371 Date: Apr. 13, 2015

Related U.S. Application Data
(60) Provisional application No. 61/712,732, filed on Oct. 11, 2012.

(51) Int. Cl. G06F 17/24; G06F 17/22

(52) U.S. Cl. CPC G06F 17/241; G06F 17/22

(57) ABSTRACT

A system and method for creating a location tag and attaching and linking multiple attributes to that tag, including such attributes as digital audio files, video files, text and photographs, thereby facilitating subsequent finding of the location in an electronic document or display. In this way, the same or a different user can proceed directly to a location of interest to view and inspect the features identified in the linked attributes.

### BACKGROUND OF THE INVENTION

1. Technical Field

The present invention relates to grouping and linking a set of multimedia rich data to a single tag tied to a specific location in an electronic document or display. The annotations include, but are not limited to, such things as text, photographs, video recordings, sound recordings, database information, and other useful content.

2. Background Art

Traditional methods of adding annotations to an electronic document or display requires the tedious creation of a multitude of disparate digital data from a variety of sources, including, but not limited to, text, images, video, audio, data feeds, databases, and more. Once the desired annotations are completed, correlating or indexing them to a variety of different, very specific locations in an electronic document or display becomes difficult and time-consuming, and the process is highly vulnerable to error. Finding annotations from a specific location (or, even more complex, finding a group of annotations that may share common or specific characteristics) quickly becomes overwhelming.

As an example: assume that a building inspector's task is to inspect all of the restrooms in a 30-story building. The restroom design and placement on all 30 floors are identical; therefore, it would be helpful to have all of the inspector's notes placed on an electronic document in the exact location and orientation where the notes were taken so as to eliminate confusion or mix-up. When the inspector generates the eventual report, it would also be helpful if the inspector could quickly find only the restroom annotations from a possible list of hundreds or even thousands of other building annotations. The current invention capitalizes on creating, organizing, and/or viewing multiple data grouped in a single marker, tag, or other identifying manner and tying that tag to a specific location and orientation in an electronic document or display, and organizing those tags either individually or by certain criteria.

### DISCLOSURE OF INVENTION

The present invention is a software program implemented on an electronic device, which allows the user to create or display multimedia rich annotations such as, but not limited to, text, photographs, video recordings, audio recordings, and/or database information, group and link those multimedia rich annotations under a marker or tag tied to a specific location on the document or display, and be able to organize markers or tags either individually or by certain criteria. The program may or may not be included as part of a larger program or suite of programs which contain additional features beyond those described.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic block diagram of a suitable representative portable electronic device for practicing the present invention;

FIG. 2 is a block diagrammatic flowchart showing how the inventive system is used;

FIG. 3 is an illustration of a portable device, showing a sample drawing and some sample location tags;

FIG. 4A is a highly schematic view showing one of many possible implementations showing the details of a sample tag manager user interface to view and organize tag details; and

FIG. 4B is a highly schematic view showing the tag manager user interface showing details for a selected tag.

### BEST MODE FOR CARRYING OUT THE INVENTION

The present invention is a software-mediated, computer-implemented program for use on an electronic device, preferably a hand held electronic device, which allows the user to create or display multimedia rich annotations such as, but not limited to, text, photographs, video recordings, audio recordings, and/or database information, group and link those multimedia rich annotations under a marker or tag tied to a specific location on the document or display, and be able to organize markers or tags either individually or by certain criteria. The program may or may not be included as part of a larger program or suite of programs which contain additional features beyond those described. The program may, but need not, be directed to documents depicting a physical space or structure. Indeed, the program may be employed to add multimedia rich data to any of a number of kinds of documents and displays.

The display feature of the program offers the user a means of optionally loading a document or a display and then visually displaying it on the electronic device.

The tagging feature of the program offers the user a means of adding tags or marks to electronic documents or display, each of which indicates a specific location and orientation on the electronic document or display and, when employed for annotating a drawing or site map, the direction (orientation) the user is facing when making such notations. Such marks are hereafter referred to as “marks” or “tags.”

The details grouped and linked by tags provides the user with a means of viewing annotations already associated with a tag and to associate new annotations with a tag. The details may be invoked by directly selecting an existing tag, or invoked independently by a button, icon, menu item, or other method such as, but not limited to, a list of available tags, forward and back buttons that allow the user to switch easily from tag to tag, or selecting from a group of tags that meet certain criteria.

An optional report function creates a multimedia report file containing all tags or a selected subset of all tags and their annotations.

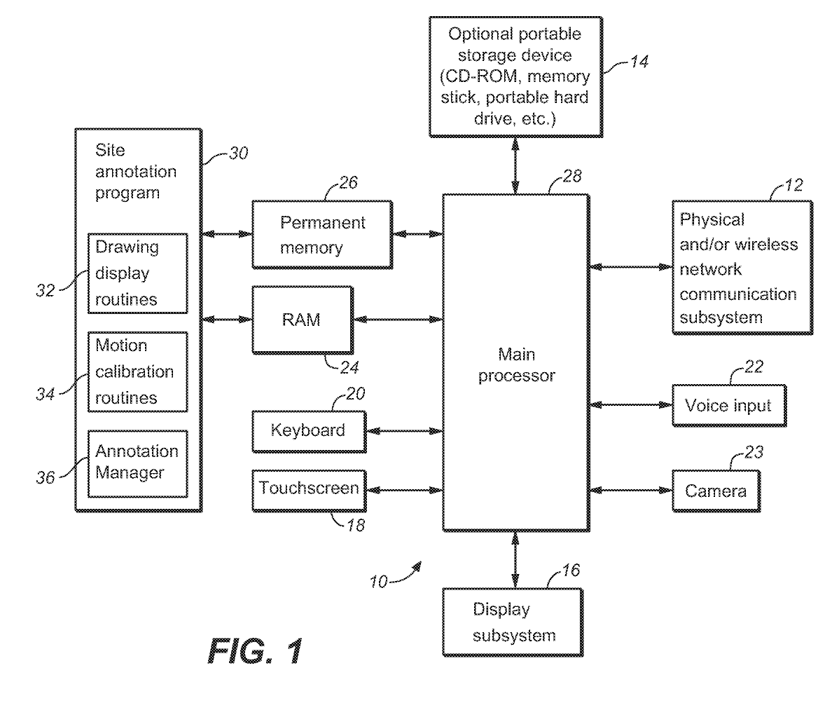

Referring now to FIG. 1, a block diagram is shown illustrating an embodiment of an electronic data device 10 suitable for use in the present invention. The electronic data device may have a variety of features and inputs, but essential components include at least a main processor 28, permanent memory 26 and temporary memory or functional equivalents 24, means to load a program stored on a computer-readable medium onto the device, possibly by a physical or wireless network communications system 12 or some form of removable media 14; a display subsystem 16; a touchscreen 18, keyboard 20, voice input 22, camera 23, or other means for the user to interact with the program. The loaded computer-executable program 30 is executed on the electronic data device and the user interface and program output is presented by the display subsystem 16.

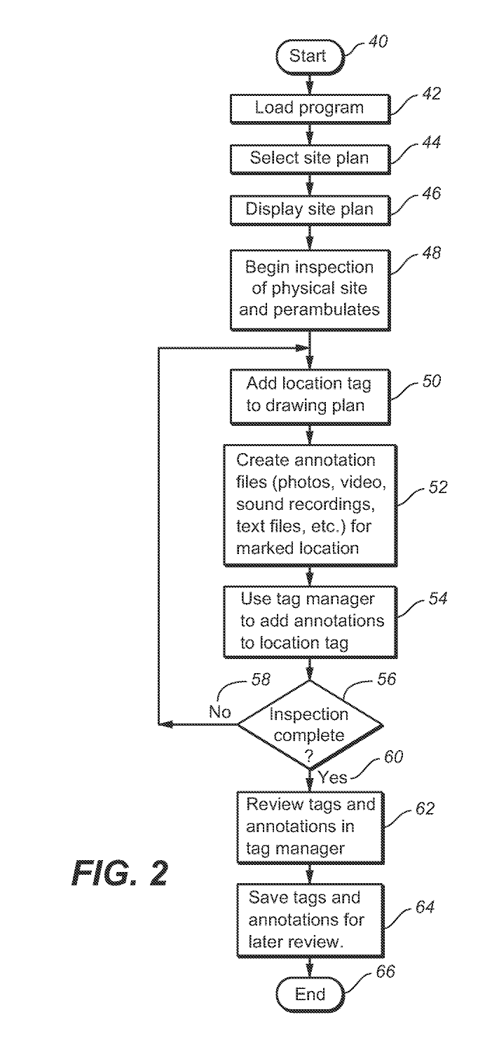

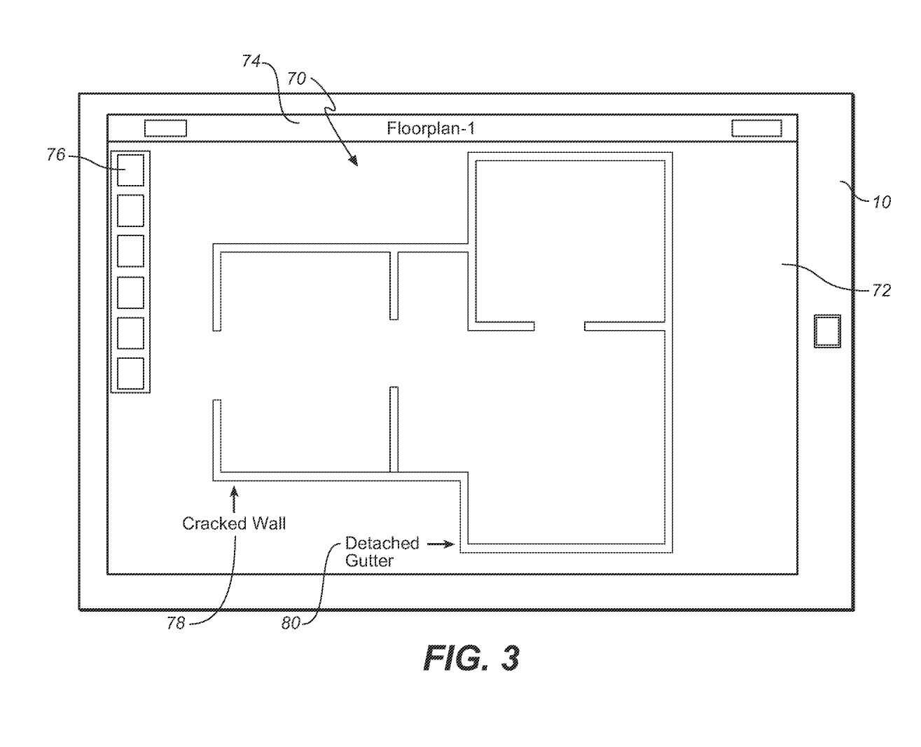

Referring next to FIGS. 2 and 3, to start use of the application 40, the program 30 (FIG. 1) is loaded 42, which program includes an optional document display routine 32, a marker placement and orientation routine 34, and annotation programming 36. After the program is loaded, the user optionally selects 44 an electronic document or drawing 70 and that is then displayed 46 by the display subsystem 16 (FIG. 1).

In this instance the document selected is a site map. Accordingly, after selecting the document, the user begins the site inspection 48, including perambulation of the physical site. During the inspection, the user may insert a location tag 50 at a point of interest on the document or display. The location and orientation may be determined by the program via either built-in sensors or other orientation capabilities/data or, if so desired, by input from the user, who may manually override the program's determined orientation by simply rotating the tag. The user may use the default title for the tag, or give it a more descriptive title. The program offers a variety of ways to add rich multimedia content 52 to that tag, including, but not limited to, optionally perambulating around and about a physical space while carrying the electronic device 10 and using built-in camera, voice, and keyboard content input, or if user already has content, simply adding that content to the detail of the tag. The user employs the tag manager 54 to add and control the annotations added to the location tag.

FIG. 3 shows a possible illustration of an electronic device 10, with a sample document 70 shown on the display surface 72. Optional title bar 74 shows the name of the document. A sample user interface bar 76 provides a possible means of initiating and inputting program commands, such as taking photos, recording video, recording audio, or adding new location tags. Two location tags 78 and 80, with desired orientation, are shown having already been marked and titled.

Having placed a location tag, and referring to FIG. 2 and FIG. 3, the user then uses controls from a sample user interface 76 to take photos, create text files, record vocal comments or other sounds, take videos, input database information or other files created outside the program, or generate/input any other sort of multimedia data 52 desired for that location. The program optionally prompts the user to indicate whether the annotation process is complete at block 56; if the process is not complete 58, the program optionally loops back to block 50 and options and method steps are repeated until the annotation process has been completed. When the annotation process is complete 60, the user may then review 62 and/or revise and save 64 tags and annotations for later review. The program for annotating the site document is then completed 66.

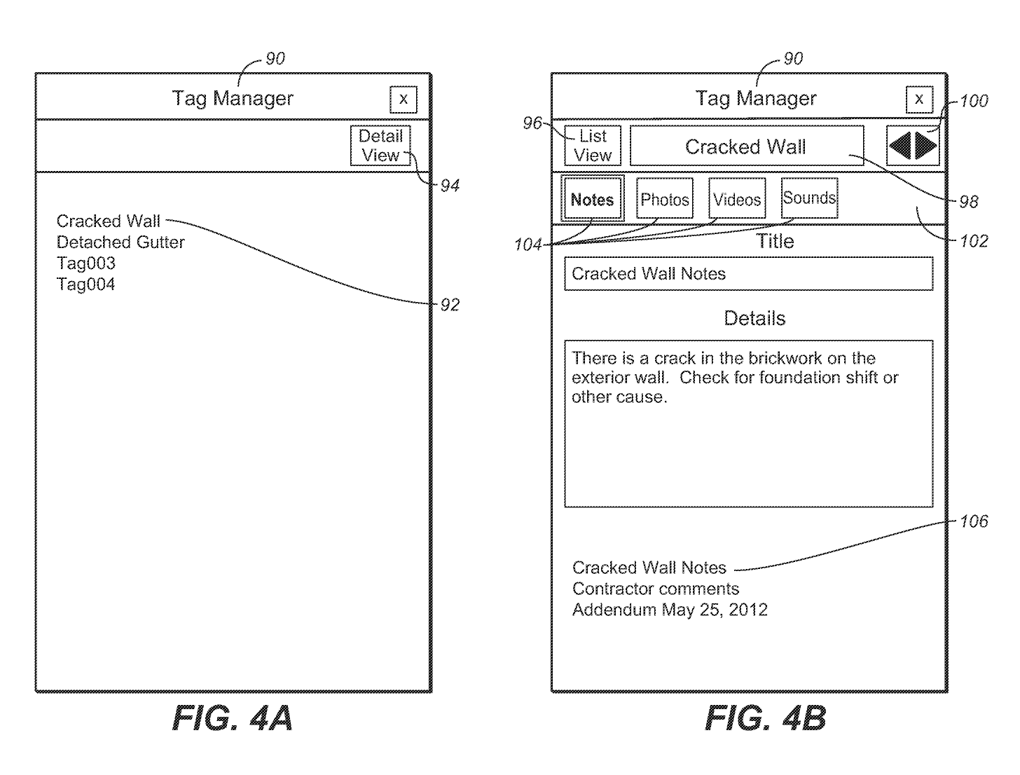

FIGS. 4A and 4B show a possible implementation of a sample tag manger user interface 90 to view and organize tag details. FIG. 4A presents a sample list view showing a sample list 92 of available tags. Optional control 94 switches from the list view to the detail view. Selecting a tag from the list 92 may also switch to the detail view for the selected tag.

FIG. 4B shows the tag manger user interface 90 presenting a detailed view for a selected tag, including a number of sample controls that perform a variety of optional functions, including but not limited to allowing user to return to a sample list view 96, showing the name of the tag currently being displayed 98, enabling the user to switch to the previous or next tag 100, or selecting tags that meet specific criteria. Sample control bar 102 provides a plurality of controls 104 to switch to and display different types of annotations for the displayed text. In this drawing, text annotations have been selected. Sample list 106 shows the list of available text notes for this tag. In the illustration, the sample text note “Cracked Walls in Restroom” has been selected for display. The detail view for other types of annotations may vary, but will include a means of selecting from a list of annotations of that type or selecting from specific criteria, and a means of optionally viewing, replaying, and editing the selected annotation.

What is claimed as invention is:

1. A method for creating and displaying multimedia rich annotations under a marker or tag tied to a document or a display on an electronic visual display on an electronic data device, comprising:
providing an electronic data device including a main processor, permanent memory, temporary memory, program loading means to load a program stored on a computer-readable medium onto said electronic data device, a display subsystem; at least one user input device;
providing a computer-readable medium including a computer-executable document annotation program with instructions that, when executed by said processor, cause said electronic data device, at the user's option, to display a document or display, and to present to the user an interface with means of adding tags to a selected document or display;
loading and executing the document annotation program on the electronic data device; and
adding one or more tags to a selected document or drawing.

2. The method of claim 1, further including grouping details linked by tags.

3. The method of claim 2, further including viewing any annotations associated with a particular tag and associating new annotations with a tag.

4. The method of claim 2, further including invoking details relating to a tag by directly selecting an existing tag.

5. The method of claim 4, further including invoking details relating to a tag by selecting a particular tag from a list of available tags.

6. The method of claim 5, wherein tag selection is accomplished using a button, icon, or menu item.

7. The method of claim 1, wherein the document annotation program includes instructions that, when executed, provide a report function that creates a multimedia report file containing all tags or a selected subset of all tags and their annotations.

8. The method of claim 7, wherein the report function causes the system to organize markers or tags either individually or by certain criteria.

9. The method of claim 1, wherein the program loading means includes at least one of a physical or wireless network communications system, a CD-ROM, a memory stick, portable hard drive.

10. The method of claim 1, wherein the at least one user input device includes a touchscreen, a keyboard, a voice input, a camera, alone or in any combination.

11. The method of claim 10, wherein rich multimedia content may be added to a tag by using any one or more of the camera, voice input, keyboard, or touchscreen.

12. The method of claim 11, wherein the document annotation program includes a tag manager to add content to a tag and to control annotations added to a location tag.

13. The method of claim 1, wherein the electronic data device further includes a location and motion tracking subsystem, and wherein the user's location may be determined selectively either by said location and motion tracking subsystem or manually by input from the user.

14. The method of claim 1, further including an orientation subsystem, wherein a tag created by a user may indicate a specific location the direction the user is facing when making the tag.

15. The method of claim 1, further including:
prompting a user to indicate whether an annotation process is complete after annotations have been made to a location tag;
wherein if the annotation process is not complete, the document annotation program continues until the annotation process has been completed; and
wherein when the annotation process is complete, the user may then review or revise and save tags and annotations for later review.

16. A system, comprising:
an electronic data device having a main processor, permanent memory, temporary memory, program loading means, a display subsystem, one or more user input devices for a user to interact with a program running on said electronic data device, location and motion tracking subsystems; and
a computer-readable medium containing a document annotation program including a document display routine, a marker placement and orientation routine, and an annotation routine with instructions that, when executed by said processor, cause said electronic data device to display a user interface providing a user with means to select a document or display to which to add tags;
wherein the user may insert a location tag at any point of interest on the document or display.

17. The system of claim 16, further including a location and motion tracking subsystem, and further wherein the document annotation program enable tags to indicate a specific location the direction the user is facing when making tags.

18. The system of claim 17, wherein the location of the user at the time of making a tag is determined by said location and motion tracking subsystem or by manual input from the user.

19. The system of claim 17, wherein said location and motion tracking subsystem includes motion and orientation detection sensors.

20. The system of claim 16, wherein said at least one user input device includes one or more of a touchscreen, a keyboard, a voice input device, and camera, alone or in any combination.

21. The system of claim 16, wherein the document annotation program includes instructions that, when executed by said processor, provides a user interface bar displayed in proximity to a selected document or display and provides means of initiating and inputting multimedia data and annotating a location tag with that data.

22. The system of claim 21, wherein said multimedia data comprises images from said camera, recorded audio from said voice input device, text files, and content from an existing database.
